(19) United States
(12) Patent Application Publication
(10) Pub. No.: US 2015/0230084 A1
(43) Pub. Date: Aug. 13, 2015

(54) TELECOMMUNICATION SYSTEM

(71) Applicant: Sirran Technologies Limited, Dublin (IE)

(72) Inventor: Dean Parsons, Dublin (IE)

(21) Appl. No.: 14/419,006

(22) PCT Filed: Jul. 17, 2013
(86) PCT No.: PCT/EP2013/065132

§ 371 Date: Feb. 2, 2015

(30) Foreign Application Priority Data
Jul. 31, 2012 (GB) 1213622.2

(51) Int. Cl. H04W 12/04; H04W 76/02

(52) U.S. Cl. CPC H04W 12/04; H04W 76/02

(57) ABSTRACT

A wireless communication system comprises: a first communication device (110); a second communication device (190) and; a target device (150), wherein the target device (150) is operable to establish a first connection over a first network with the first communication device (110) and a second connection over a second network with the second communication device (190), characterised in that first data which is exchanged between the first communication device (110) and the target device (150) is encrypted by an encryption means, and in that second data which is exchanged between the second communication device (190) and the target device (150) is unencrypted, such that a first user of the first communication device (110) can communicate with a second user of the second communication device (190).

### FIELD OF INVENTION

The present invention relates to a wireless communication system in which a mobile communication device communicates with a telecommunications network, wherein secure communication can be provided.

### BACKGROUND OF THE INVENTION

Provision of secure communication between mobile devices involves providers of encrypted voice calls on mobile devices providing point to point calling between devices that have encryption capability built into them. Although this provides secure calling between devices it severely limits the scope of potential use since the lack of ability to make or receive calls from standard or non-secure mobile devices can exclude up to 99.9% of mobile devices used globally.

Furthermore, users of mobile devices can protect data, content or information transmitted from and/or received by the mobile device using encryption. Henceforth, such data, content or information will be referred to as “secured information”. In certain circumstances there is a need to record or retrieve this secured information which may have been encrypted and may have only temporarily been stored or processed by the mobile device. Such circumstances may arise for various reasons such as legal or commercial reasons ranging from a warrant being issued to provide for a “tap” on the mobile device, wherein a lawful interception of the secured information is required, or simply to provide for regulatory compliance, for instance via FSA compliance.

In general, when a secure communication connection is established between two devices, an encryption key is exchanged between them in a “peer-to-peer” manner, wherein the encryption key is a shared secret only shared between the two devices in communication and the encryption key is generally deleted once that particular secure communication connection has been terminated. This can make the decryption and/or recording of any encrypted secured information, such as voice or video data between two mobile devices, problematic.

It is an objective of embodiments of the present invention to overcome one of the above or other problems associated with the prior art.

### SUMMARY OF THE INVENTION

According to a first aspect of the invention there is provided a wireless communication system comprising:

a first communication device;

a second communication device and;

a target device,

wherein the target device is operable to establish a first connection over a first network with the first communication device and a second connection over a second network with the second communication device,

characterised in that first data which is exchanged between the first communication device and the target device is encrypted by an encryption means, and in that second data which is exchanged between the second communication device and the target device is unencrypted, such that a first user of the first communication device can communicate with a second user of the second communication device.

Preferably, the target device comprises a server connected to a target network.

Preferably, the encryption means is configured to prevent a third party from decrypting the encrypted first data.

Preferably, one or both of the first and second networks are a wireless network. Preferably the first and second networks are the same network.

Preferably, the encryption means comprises the server configured to perform protocol conversion on the first data received from or transmitted to the first communication device.

Preferably the protocol conversion comprises one or more of the following: Session Initiation Protocol (SIP), Time-Domain Multiplexing (TDM), and/or Transport Layer Security (TLS); media termination functionality using Real-time Transport Protocol (RTP); secure media termination functionality using ZRTP or Secure RTP (SRTP); and/or a transcoding engine for coding standards such as G711, G729 and/or Global System for Mobile communication Full-Rate (GSMFR).

Preferably, the encryption means further comprises the first communication device configured to encode or decode the first data in accordance with the protocol used for the first connection with the server.

Preferably, the system is configured such that the first connection is established by means of exchanging an encryption key between the first communication device and the server.

Preferably, the encryption key comprises a 4096 bit Diffie Helman, and the encryption is AES256.

Preferably, the first network is a secure network. Preferably, the second network is an unsecure network. Herein a secure network being defined as any network which is encrypted to deter or hinder a third party from accessing the network.

Preferably, the server is configured to perform protocol conversion on the second data received from or transmitted to the second communication device.

Preferably, the second network comprises a Public Switched Telephone Network (PSTN) preferably operatively connected the second communication device, preferably in the form of a fixed phone and/or mobile handset. Preferably, the server is operable to route from the fixed phone or mobile handset via the PSTN and target device a call to an identification means assigned to the first communication device by the server, to preferably enable the second communication device to call the first communication device. Preferably, the identification means is an IP address, MAC address or other suitable means which is operable to identify the first communication device on the first network.

Preferably, the server is configured to provide for an exchange of heartbeat data, such that the first connection remains established and a call from the second communication device can be answered by the first communication device. Preferably the heartbeat data comprises an encrypted message, the exchange of which facilitates confirmation of the status of the first communication device and/or the identification means of the first device.

Preferably, the wireless communications system operates in accordance with one or more of the following standards: GSM, 2G, 2.5G (GPRS), 2.75G (EDGE), 3G and 4G.

According to a second aspect of the invention there is provided a method of transferring information a between a first communication device and a second communication device, the method comprising:

establishing a first connection over a first network between a target device and the first communication device;

establishing a second connection over a second network between the target device and second communication device,

characterised in that first data which is exchanged between the first communication device and target device is encrypted by an encryption means, and in that second data which is exchanged between the second communication device and target device is unencrypted, such that a first user of the first communication device and can communicate with a second user of the second communication device.

Preferably, the transferred information comprises audio or video data for a communication between the first and second user of the first and second device respectively.

Preferably, the wireless communications system is configured to send information via the first and/or second network using Voice over Internet Protocol (VoIP) over a typical mobile data session.

Preferably, the wireless communications device is a mobile device, such as a mobile handset or a tablet PC.

Preferably, the first communication device is located in a potentially hostile environment and the second communication device and target device is located in a safe environment. Herein a hostile environment is defined as a Country or region wherein hacking of a phone conversation is anticipated.

According to a third aspect of the invention there is provided a wireless communication system comprising:

a first communication device;

a second communication device; and

a target device,

wherein the target device is operable to establish a first connection with the first communication device and a second connection with the second communication device, such that a first user of the first communication device can communicate with a second user of the second communication device,

and wherein the system is configured such that first data which is exchanged between the first communication device and the target device is encrypted by an encryption means,

characterised in that the target device is operably connected to a monitoring station, the monitoring station being operable to receive the first data from the target device and to output the first data in a unencrypted form.

Optionally, the system is configured such that second data which is exchanged between the second communication device and the target device is encrypted by the encryption means. Optionally, the system is configured such that second data which is exchanged between the second communication device and the target device is not encrypted. Optionally, the monitoring station is operable to receive the second data from the target device and to output/record the second data in a unencrypted form.

Preferably, the target device is configured such that the first and second data are routed through the monitoring station.

Preferably, the target device comprises a first media termination point (MTP) to terminate a stream of the first data in the target device and route the first data to the monitoring station.

Preferably, the target device comprises a second media termination point (MTP) to terminate a stream of the second data in the target device and route the second data to the monitoring station.

Preferably, the output of data in an unencrypted form comprises output of unencrypted data and/or encrypted data together with an associated decryption and/or encryption key.

Preferably, the target device comprises a server connected to a target network. Preferably, the monitoring station is configured to connect to the target network by means of a network connection. Alternatively, the monitoring station is part of the target network.

Preferably, the encryption means is configured to prevent a third party from decrypting the encrypted first and/or second data.

Preferably, the encryption means comprises the server configured to perform protocol conversion on the first data received from or transmitted to the first communication device and/or protocol conversion on the second data received from or transmitted to the second communication device.

Preferably the protocol conversion comprises one or more of the following: Session Initiation Protocol (SIP), Time-Domain Multiplexing (TDM), and/or Transport Layer Security (TLS); media termination functionality using Real-time Transport Protocol (RTP); secure media termination functionality using ZRTP or Secure RTP (SRTP); and/or a transcoding engine for coding standards such as G711, G729 and/or Global System for Mobile communication Full-Rate (GSMFR).

Preferably, the encryption means further comprises the first communication device configured to encode or decode the first data in accordance with the protocol used for the first connection with the server.

Preferably, the encryption means further comprises the second communication device configured to encode or decode the second data in accordance with the protocol used for the second connection with the server.

Preferably, the system is configured such that the first connection is established by means of exchanging a first encryption key between the first communication device and the server.

Preferably, the system is configured such that the second connection is established by means of exchanging a second encryption key between the second communication device and the server.

Preferably, the first and second encryption keys are specific to the first and second connection, respectively. Alternatively, the first and second encryption keys are the same.

Preferably, the encryption key comprises a 4096 bit Diffe Helman, and the encryption is AES256.

Preferably, the first connection is established over a first network and the second connection is established over a second network. Preferably, the first and/or second connection is a wireless connection. Optionally, the first and second networks are the same network.

According to a fourth aspect of the present invention there is provided a method of monitoring an encrypted call, the method comprising steps of:

establishing a first connection over a first network between a target device and a first communication device;

establishing a second connection over a second network between the target device a second communication device,

such that a first user of the first communication device can communicate with a second user of the second communication device, and wherein the system is configured such that first data which is exchanged between the first communication device and the target device is encrypted by an encryption means,

characterised in that the method further comprises a step of transferring the first data to a monitoring station, and a further step of outputting/recording the first data from/on the monitoring station in a decrypted form.

All of the features described herein may be combined with any of the above aspects, in any combination.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 shows a schematic of a communication system according to a first embodiment of the present invention;

FIG. 2 shows the schematic of the communication system of FIG. 1 in more detail;

FIG. 3 shows a first schematic of a communication system according to a second embodiment of the present invention; and

FIG. 4 shows a second schematic of the communication system of FIG. 3.

### DETAILED DESCRIPTION OF THE EXEMPLARY EMBODIMENTS

According to a first embodiment of the present invention, there is provided a communication system for making a call between a first communication device, defined herein as a secure mobile device, and a second communication device defined herein as an unsecure mobile device. The calling between a secure mobile device and unsecure mobile device is referred to herein as a “hybrid call”.

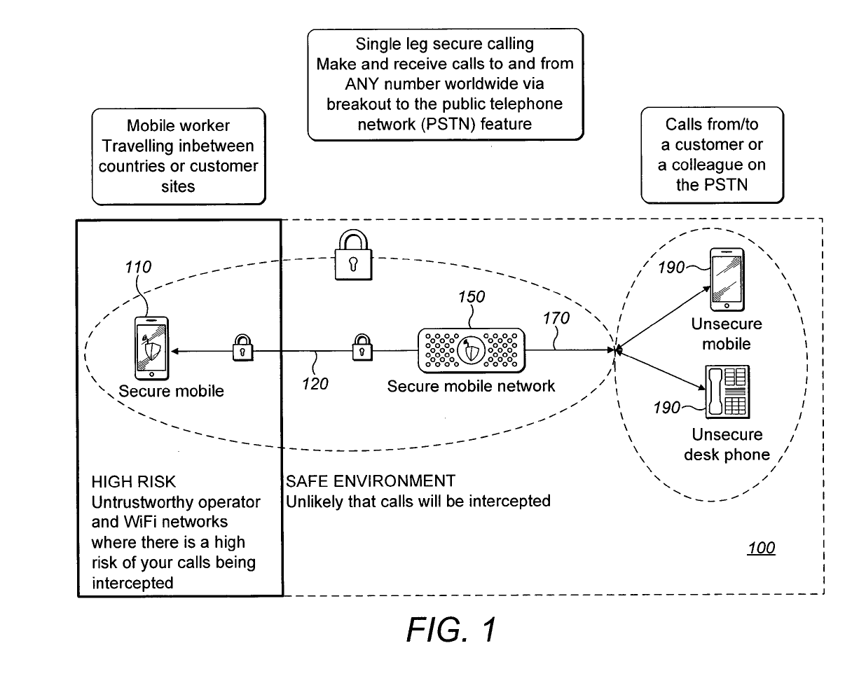

Referring to FIG. 1, a schematic of a communication system 100 according to a first embodiment of the invention is shown, wherein the communication system 100 comprises a secure client which comprises a computer program that operates on the secure mobile device 110, and a target device 150 embodied in this example as a computer server. The secure client is configured to run on the secure mobile device 110 and the server 150 is connected to a computer network which is a secure mobile telecommunication network. It will be appreciated that that the network which the server is connected be a Wi-fi network, a Local Area Network (LAN) or any other type of network whereby the secure client and the server 150 can establish a connection and transmit and/or receive data therebetween.

In this embodiment the secure mobile device 110 is a mobile handset. In alternative embodiments, the first secure mobile device 110 may be a PDA, a telecommunications laptop, or any other device on which the secure client can run. The server 150 acts as a gateway for both secure and non-secure traffic since a hybrid call involves both secure and non-secure traffic. The server 150 itself includes appropriate security measures such as an encryption in place so that any information held at or passing through the server 150 can be protected.

Once a first network connection, termed herein a secure connection 120, is established between the secure client and the server 150, the server 150 provides for protocol conversion of information exchanged therebetween, wherein the hybrid call comprises the information exchanged therebetween. According to an embodiment of the present invention, when the secure client on the secure mobile device 110 sends or receives the information, such as voice or video data from the secure mobile device 110, to and from the server 150, the server 150 provides for protocol conversion using: Session Initiation Protocol (SIP), Time-Domain Multiplexing (TDM), and/or Transport Layer Security (TLS); media termination functionality using Real-time Transport Protocol (RTP); secure media termination functionality using ZRTP or Secure RTP (SRTP); and/or a transcoding engine for coding standards such as G711, G729 and/or Global System for Mobile communication Full-Rate (GSMFR). In this way interoperability between the secure mobile device 110 and server 150 is achieved.

To set up the hybrid call, the secure mobile device 110 initiates a data session with the server 150 and requests a hybrid call to be set up to an unsecure mobile device 190. In this example the second communication device (unsecure mobile device) 190 comprises a conventional mobile handset. However, it will be appreciated that the second communication device 190 may also be a PDA, a laptop, fixed line phone, or any other telecommunications device connectable to the server via an unsecure connection or network, termed herein as a second network connection. The server 150 establishes a secure connection 120 with the secure mobile device 110. Suitably the server 150 also establishes a second network connection 170 with the unsecure mobile device 190 and provides for the protocol conversion, media termination functionality, secure media termination functionality and/or a transcoding engine required for the hybrid call. In this way information such as voice or video data can be transmitted and received between the secure mobile device 110 and the unsecure mobile device 190 during the hybrid call. In an alternative embodiment, the information transmitted and received between the devices during the hybrid call is any data.

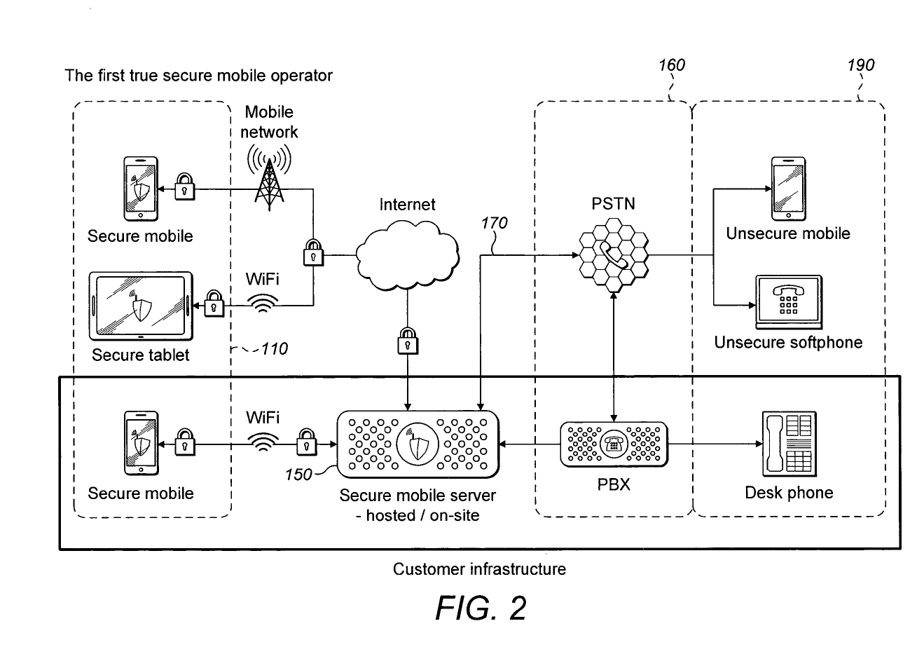

FIG. 2 shows a schematic of the first embodiment in more detail, wherein the server 150 establishes the second network connection 170 to a Public Switched Telephone Network (PSTN) or a Private Branch Exchange (PBX) 160 which is operable to communicate with the unsecure mobile device 190.

In this configuration, the server 150 provides, via the standard Public Switched Telephone Network (PSTN) or PBX, mobile handset number/fixed phone routing functionality. For instance, the server 150 is capable of mapping the PSTN or mobile handset number to an IP address/end point assigned to a specific secure mobile device 110. This enables an unsecure mobile device 190 to initiate a call to the specific secure mobile device 110 by dialing a number for the specific secure mobile device 110 since the server 150 can route/map the number to the assigned IP address or end point of the specific secure mobile 110.

This routing functionality enables the unsecure mobile device 190 to initiate the hybrid call to the secure mobile device 110 by simply dialing the number for the secure mobile device 110. To set up a hybrid call, a user dials the number for the secure mobile device 110, the server routes/maps the number to an IP address/end point assigned to the secure mobile device 110, wherein the server 150 establishes a secure connection 120 with the first secure mobile device 110. Suitably the server 150 also provides for the protocol conversion, media termination functionality, secure media termination functionality and/or a transcoding engine required for the hybrid call, wherein information such as voice or video data is transmitted and received between the secure mobile device 110 and the unsecure mobile device 190.

The server 150 acts as a gateway between secure and unsecure environments connected via the secure 120 and unsecure 180 connection/network respectively. The server 150 enables the hybrid call to take place by providing for the protocol conversion, media termination functionality, secure media termination functionality and/or a transcoding engine required for the hybrid call, whereby the hybrid call connects the secure mobile device 110 to the unsecure mobile device 190 via an unsecure connection/network 170 such as the PSTN, the standard mobile network or the user's own system such as PBX, a virtual PBX or an IP PBX 160.

Once the first connection has been established between the secure mobile device 110 and the server 150, a regular exchange of heartbeat data, such as that provided by a heartbeat connection is provided. The heartbeat data comprises an encrypted message, the exchange of which being able to confirm the status of the secure mobile device 110. In this way it is ensured that a connection remains established until a connection termination request has been made. Such a heart beat connection is optionally applied to the second connection 170. In particular, by ensuring the secure connection 120 remains established, any inbound call to a secure mobile device 110 connected via the secure connection 120 can be readily received and any outbound call therefrom can be initiated without having to re-establish the secure connection 170.

The features described herein can be particularly useful when a first user of a secure mobile device 110 is located in a potentially hostile environment and a second user of an unsecure mobile device 190 is located in a safe environment, wherein the secure mobile device 110 is connected to a secure network with encryption capability and the unsecure mobile device 1190 is connected to a trusted network or lacks the encryption capability. The reason for the lack of the encryption capability might be because there is a low risk of interception or any other known reasons for excluding such capability. The ability to call between these two types of mobile devices, namely secure and unsecure devices, enables network providers of such mobile device network services to reach larger demographic and increase the mobile device utilisation whilst still providing sufficient and targeted protection where the risk might be high.

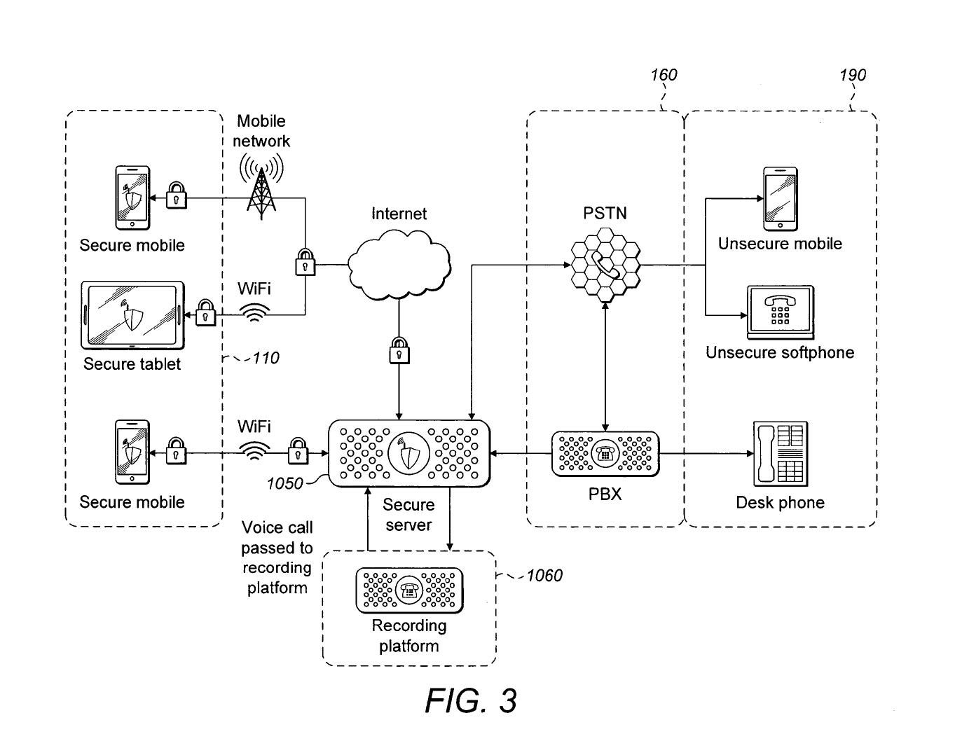

Referring to FIG. 3, a first schematic of a communication system of a second embodiment of the invention is shown. According to this particular embodiment, there is provided a communication system 1000 comprising a first communication device 110, a target device 1050, and a second communication device 190. The target device is embodied in this example as a computer server 1050. A secure client comprising a computer program runs from at least the first communication device 110, which is this example is a first secure mobile device 110.

The sever 1050 is configured to act as a gateway for both secure and non-secure traffics. Any information held on or processed by the server 1050 is protected with appropriate security measures such as an encryption so that the information at or passing through the server can be protected.

To effect communication between the devices a first connection is established between the first secure mobile device 110 and the server 1050, the server 1050 provides for protocol conversion of information exchanged there between as discussed in the above first embodiment of the invention. When the secure client of the first secure mobile device 110 sends or receives information, such as voice or video data, to and from the server 1050, the server 1050 provides for protocol conversion using: Session Initiation Protocol (SIP), Time-Domain Multiplexing (TDM), and/or Transport Layer Security (TLS); media termination functionality using Real-time Transport Protocol (RTP); secure media termination functionality using ZRTP or Secure RTP (SRTP); and/or a transcoding engine for coding standards such as G711, G729 and/or Global System for Mobile communication Full-Rate (GSMFR).

To set up a call, the first secure mobile device 110 initiates a data session with the server 1050 and requests a call to be set-up to the second mobile device 190. The server 1050 thereafter establishes a first and second connection with each of the first and second mobile devices.

It will be appreciated that both the first and second communication devices 110,190 can be secure or unsecure mobile devices, with the invention requiring that at least one of the devices is secure; however in this example they are both described as secure mobile devices. Herein a secure mobile device is defined as a device configured to send/receive encrypted data to prevent access by a third party. It will also be appreciated that the first and second communication devices are not restricted to being mobile devices, for instance, they may also be fixed phone devices connected via a PSTN, or PBX network.

The server 150,1050 provides for appropriate protocol conversion, media termination functionality, secure media termination functionality and/or a transcoding engine required for the call, such that secured information such as voice or video data transmitted and received from the first and second secure mobile devices can be decrypted on the server 1050 as described in the description for the first embodiment.

The decrypted information is then routed through a monitoring station in the form of a recording platform 1060, which in this example comprises a storage medium with an IP address. The recording platform 1060 is capable of recording/storing the secured information on to the storage medium, so that the decrypted secured information can be stored on the recording platform 1060.

It will be appreciated that according to an alternative embodiment, the recording platform 1060 does not comprise a storage medium but an output channel of some kind, whereby an authorised party can receive the decrypted secured information and monitor/make further recordings in real time.

It will also be appreciated that recording platform 1060 may be part of the server 1050 or on a separate device connected to the server 1050 via a network.

It will also be appreciated that information stored on the recording platform 1060 may be stored in an encrypted state. This is achieved by allowing the encryption key used for encrypting the information on the recording platform 1060 to be available, recording of the secured information can be then accessed by any authorised parties.

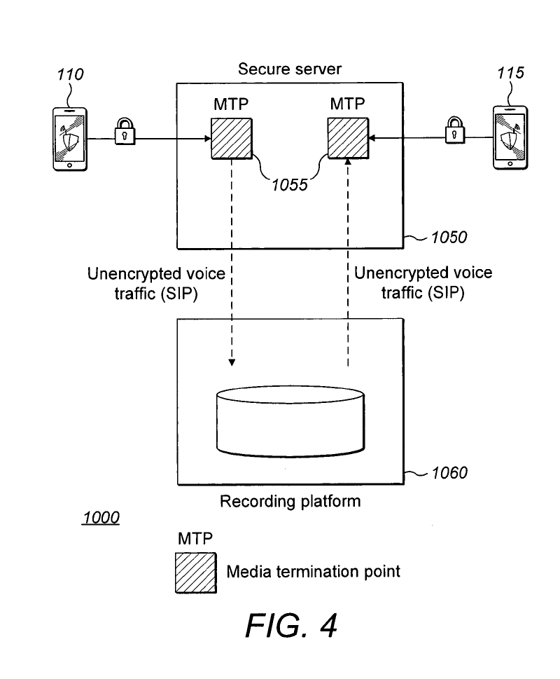

Referring to FIG. 4, a second schematic of the communication system according to the second embodiment, shows in invention in more detail.

In order to route the decrypted information through the recording platform 1060, the server comprises a Media Termination Point (MTP) 1055 configured to terminate a media stream from the first secure mobile device 110 and a further MTP 1055 configured to terminate a media stream from the a second secure mobile device 115. In this way the server 1050 can decrypt the information and re-direct the decrypted information, between the first 110 and second 115 secure mobile device, to the recording platform 1060. When the information is received from the first or second mobile device, the server 1050 introduces a new call leg to and from the recording platform 1060 before transmitting the information to the other of the first or second mobile device, whereby the information can be recorded/stored on the recording platform 1060.

It will be appreciated that in an alternative embodiment, the information is routed through the recording platform 1060 in an encrypted form, wherein a key for decrypting the encrypted secured information is also routed to the recording platform 1060. In such alternative embodiment, the recording platform 1060 may perform the decryption or merely store the key for the decryption with the encrypted secured information.

Referring back to the second embodiment, a user activates a secure client on a first mobile device 110, the secure client initiates a session with a server 1050, and if a call is requested then an encryption key is exchanged between the secure client on the first secure mobile device 110 and the server 1050. In this example the secure connection is established there between using ZRTP, SRTP and/or TLS for SIP traffic. The server 1050 also performs media termination and protocol conversion where appropriate. It will be appreciate that a call is initiated by the second mobile device in a similar fashion.

Once a connection has been established between the secure client of the mobile device and the server 1050, a regular exchange of heartbeat data occurs as described in the first embodiment, to ensure the secure connection remains established until a connection termination request has been made. Thereafter, if a secure call is requested an encryption key is exchanged between the secure mobile device and server, which is this example, is a 4096 bit Diffie Helman Key, and the encryption is AES256. Hence the encryption and key exchange comprises an encryption means to provide secure communication between the mobile device and server.

By ensuring the connection remains established, any inbound call to the first secure mobile device 110, whereon the secure client runs, can be readily received and any outbound call therefrom can be initiated without having to re-establish the connection.

The server 1050 is configured to decrypt secured information and route the information from the first secure mobile device 110 through the recording platform 1060. The recording platform 1060 then records or stores the decrypted secured information. If a call is requested to a second secure mobile device 115, i.e. two secure mobile devices are in conversation with each other, the server 1050 is configured to decrypt and route information from both secure mobile devices according to the embodiment described above, whereby the recording platform 1060 records or stores the decrypted secured information thereon.

It will be appreciated that in an alternative embodiment, more than two secure mobile devices may be in conversation and the method, devices and server described in the above embodiments are adapted to enable the present invention to be implemented in such alternative or any other alternative configurations.

It will also be appreciated that some or all of the features described herein with regard to the server can be present on the mobile device, or vice versa. According to one embodiment, a single device comprises all or some of the features described herein with regard to the server and the mobile device.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-15. (canceled)

16. A wireless communication system comprising:
a first communication device;
a second communication device and;
a target device,
wherein the target device is operable to establish a first connection over a first network with the first communication device and a second connection over a second network with the second communication device,
characterised in that first data which is exchanged between the first communication device and the target device is encrypted by an encryption means, and in that second data which is exchanged between the second communication device and the target device is unencrypted, such that a first user of the first communication device can communicate with a second user of the second communication device.

17. The wireless communication system of claim 16, in which the target device comprises a server connected to a target network.

18. The wireless communication system of claim 16, in which, one or both of the first and second networks are wireless network(s).

19. The wireless communication system of claim 1, in which the first and second networks are the same network.

20. The wireless communication system of claim 16, in which the encryption means comprises the server configured to perform protocol conversion on the first data received from or transmitted to the first communication device.

21. The wireless communication system of claim 16, in which the encryption means further comprises the first communication device configured to encode or decode the first data in accordance with the protocol used for the first connection with the server.

22. The wireless communication system of claim 16, in which the system is configured such that the first connection is established by means of exchanging an encryption key between the first communication device and the target device.

23. The wireless communication system of claim 16, in which the second network comprises a Public Switched Telephone Network (PSTN) operatively connected the second communication device, optionally in the form of a fixed phone and/or mobile handset.

24. The wireless communication system of claim 16, in which the server is configured to provide for an exchange of heartbeat data, such that the first connection remains established and a call from the second communication device can be answered by the first communication device.

25. The wireless communication system of claim 16, in which the heartbeat data comprises an encrypted message, the exchange of which facilitates confirmation of the status of the first communication device and/or the identification means of the first device.

26. A method of transferring information a between a first communication device and a second communication device, the method comprising:
establishing a first connection over a first network between a target device and the first communication device; and
establishing a second connection over a second network between the target device and second communication device,
characterised in that first data which is exchanged between the first communication device and target device is encrypted by an encryption means, and in that second data which is exchanged between the second communication device and target device is unencrypted, such that a first user of the first communication device and can communicate with a second user of the second communication device.

27. The method of claim 26, in which, the first communication device is located in a potentially hostile environment and the second communication device and target device is located in a safe environment.

28. A wireless communication system comprising:
a first communication device;
a second communication device; and
a target device,
wherein the target device is operable to establish a first connection with the first communication device and a second connection with the second communication device, such that a first user of the first communication device can communicate with a second user of the second communication device,
and wherein the system is configured such that first data which is exchanged between the first communication device and the target device is encrypted by an encryption means,
characterised in that the target device is operably connected to a monitoring station, the monitoring station being operable to receive the first data from the target device and to output the first data in a unencrypted form.

29. The wireless communication system of claim 28, in which the system is configured such that second data which is exchanged between the second communication device and the target device is encrypted by the encryption means.

30. The wireless communication system of claim 28, in which the target device comprises a first media termination point (MTP) to terminate a stream of the first data in the target device and route the first data to the monitoring station.

31. The wireless communication system of claim 28, in which the target device comprises a second media termination point (MTP) to terminate a stream of the second data in the target device and route the second data to the monitoring station.

32. The wireless communication system of claim 28, in which the target device comprises a server connected to a target network.

33. The wireless communication system of claim 33, in which the encryption means comprises the server configured to perform protocol conversion on the first data received from or transmitted to the first communication device and/or protocol conversion on the second data received from or transmitted to the second communication device.

34. The wireless communication system of claim 28, in which the first connection is established over a first network and the second connection is established over a second network.

35. The wireless communication system of claim 34, in which the first and second networks are the same network.
